(19) United States
(12) Patent Application Publication
(10) Pub. No.: US 2023/0108366 A1
(43) Pub. Date: Apr. 6, 2023

(54) SYSTEMS FOR ENCRYPTION USING BLOCKCHAIN DISTRIBUTED LEDGERS

(71) Applicant: c/o NIFTY CONCEPTS LLC, Holland, OH (US)

(72) Inventors: Victor W. Tang, Clyde Hill, WA (US); Phillip S. Runyan, Holland, OH (US)

(21) Appl. No.: 17/959,911

(22) Filed: Oct. 4, 2022

Related U.S. Application Data
(60) Provisional application No. 63/252,162, filed on Oct. 5, 2021.

(51) Int. Cl. G06Q 20/36; H04L 9/00; G06Q 20/38

(52) U.S. Cl. CPC G06Q 20/3672; H04L 9/50; G06Q 20/3829; G06Q 20/3821; G06Q 2220/00

(57) ABSTRACT

Systems and methods for encryption using blockchain distributed ledgers include a memory, one or more processors in communication with the memory, and program instructions executable, via the memory, by the one or more processors to, in part, encrypt, via a symmetric key, multiple documents to be incorporated into a single non-fungible token (NFT). Further, a data file including a portfolio array of links to each encrypted document of the multiple encrypted documents is generated, and a mint function is executed to create the single NFT on a blockchain, where the single NFT includes a link to the generated data file. The single NFT is transmitted to a digital wallet of the blockchain.

### CROSS-REFERENCE TO RELATED APPLICATIONS

This application claims priority benefit of U.S. Provisional Patent Application No. 63/252,162, filed on Oct. 5, 2021, and entitled Secure Portfolio Non-Fungible Tokens, the entire contents of which is hereby expressly incorporated herein by reference in its entirety.

### FIELD OF THE INVENTION

This invention relates generally to non-fungible tokens (NFTs), and more particularly, embodiments of the invention relate to the use of a computing system for encryption using blockchain distributed ledgers.

### BACKGROUND OF THE INVENTION

A blockchain is a peer-to-peer, electronic ledger that includes a chain of blocks of data, where each block includes one or more transactions. Each transaction points back to a preceding transaction in a sequence, which may span one or more blocks. Blockchain-based content engagement platforms may include a registry services that enable verified content creators to mint NFTs. NFTs can be created for a large range of real world media content and intellectual property including artwork and collectibles. NFTs can have multifunctional programmable use cases including private access to premium content and experiences.

The marketplace for minting and selling NFTs has blossomed in the last few years and has predominantly been active on the Ethereum blockchain. NFTs evolved from the Ethereum Request for Comments 721 (ERC-721) standard that implements an application programming interface (API) for tokens within smart contracts, where the token is unique and can have a different value than another token from the same smart contract. NFTs allow for the transfer of tokens from one user account to another.

However, the ERC 721 standard only allows for one single master document to be included when minting an NFT. This limitation restricts inclusion within the same NFT of associated documents that provide, for example, proof of ownership of the master document, or documents that may enhance or support the value of the master document. Existing functionality requires that each associated document is separately minted in separate NFT tokens. Additionally various concerns related to privacy of the single document arise, and any NFT becomes immediately accessible by anyone with the ability to find the NFT. Thus, a need exists for improved systems and methods for addressing these shortcomings.

### BRIEF SUMMARY

Shortcomings of the prior art are overcome and additional advantages are provided through the provision of a computing system for encryption using blockchain distributed ledgers. The system includes a memory, one or more processors in communication with the memory, and program instructions executable by the one or more processors via the memory to encrypt, via a symmetric key, one or more documents to be incorporated into a single non-fungible token (NFT). Further, execution of the program instructions generates a data file including a portfolio array of links to each of the one or more encrypted documents, and executes a mint function to create the single NFT on a blockchain, the single NFT including a link to the generated data file. Execution of the program instructions also transmits the single NFT token to a digital wallet of the blockchain.

Additionally, disclosed herein is a computer-implemented method for encryption using blockchain distributed ledgers, where the computer-implemented method includes encrypting, via a symmetric key, multiple documents to be incorporated into a single non-fungible token (NFT). The method further includes generating a data file that includes a portfolio array of links to a plurality of documents, where the plurality of documents include (i) the encrypted multiple documents and (ii) unencrypted versions of the multiple documents, where each link points to a single document of the plurality of documents. Further a mint function is executed to create the single NFT on a blockchain, where the single NFT includes a link to the generated data file. Also, the single NFT is transmitted to a digital wallet of the blockchain.

Also, disclosed herein is a computer-implemented method for authorization of encrypted documents using blockchain distributed ledgers, where the computer-implemented method includes receiving a request to view a non-fungible token (NFT) that includes a link to access an encrypted data file that includes a portfolio array of links to multiple encrypted documents. Further, the computer-implemented method determines, based on receiving the request, whether the received request is authenticated, and accesses a file system network that includes (i) the multiple encrypted documents, and (ii) unencrypted versions of the multiple encrypted documents, wherein the unencrypted versions are variations of the multiple encrypted documents. Based on determining that the received request is not authenticated, the computer-implemented method provides the unencrypted versions of the multiple encrypted documents.

Additional features and advantages are realized through the concepts described herein.

### BRIEF DESCRIPTION OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 depicts an example computing environment that includes blockchain node networks and a file system network, according to an implementation of the present disclosure;

FIG. 2 depicts a block diagram of an example computing system for encryption using blockchain distributed ledgers, according to an implementation of the present disclosure;

FIG. 3 depicts an example user interface visible via a computing device, according to an implementation of the present disclosure;

FIG. 4 depicts an example data file that includes NFT properties and portfolio properties for multiple documents, according to an implementation of the present disclosure;

FIG. 5 depicts an example sequence diagram for creating an NFT, according to an implementation of the present disclosure;

FIG. 6 depicts an example sequence diagram for accessing encrypted documents via an NFT that includes a link to a data file, according to an implementation of the present disclosure;

FIG. 7 depicts an example sequence diagram for registering a new user to have access to encrypted documents using an NFT that includes a link to a data file, according to an implementation of the present disclosure;

FIG. 8 depicts an example diagram of a database that is used by a host computing system, according to an implementation of the present disclosure;

FIG. 9 depicts an example sequence diagram for authorizing an additional user to access encrypted documents via an NFT that includes a link to a data file, according to an implementation of the present disclosure;

FIG. 10 depicts an example method for encrypting documents on a single NFT, according to an implementation of the present disclosure;

FIG. 11 depicts a flowchart of an example method for authorization of encrypted documents using blockchain distributed ledgers, according to an implementation of the present disclosure;

FIG. 12 depicts a flowchart of an example method for authorization of encrypted documents using blockchain distributed ledgers, according to an implementation of the present disclosure;

FIG. 13 depicts a flowchart of an example method for authorizing an additional user to access encrypted documents via an NFT that includes a link to a data file, according to an implementation of the present disclosure; and

FIG. 14 depicts a block diagram of an asset privacy service, according to an implementation of the present disclosure.

### DETAILED DESCRIPTION

Aspects of the present invention and certain features, advantages, and details thereof are explained more fully below with reference to the non-limiting examples illustrated in the accompanying drawings. Descriptions of well-known processing techniques, systems, components, etc. are omitted so as to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code.

As described herein, the term “blockchain” includes all forms of electronic, computer-based distributed ledgers such as, for example, consensus-based blockchain and transaction-chain technologies, permissioned and unpermissioned ledgers, shared ledgers and variations thereof. Example blockchain-based networks may include a logical structure of blocks chained together by, for example, cryptographic hash pointers and each block may include a header that provides verification of data recorded in the specific block as well as from prior blocks in the chain. Specific blockchain platforms such as Bitcoin or Ethereum may be referred to herein as non-limiting examples for the purposes of convenience and illustration and various alternative blockchain platforms (e.g., Bitcoin Satoshi Vision (BSV), Polygon, Solana, Tezos, Hyperledger, Cardano, Neo, etc.) are within the scope of the present disclosure.

As described herein, the term “non-fungible token (NFT)” refers to any cryptographic asset having unique identification codes and metadata that make the asset individually distinguishable. NFTs are not mutually interchangeable and each NFT represents a unique cryptographic asset. Generally, an NFT is created via a cryptographic transaction process that provides a digital signature that tracks NFT ownership. This digital signature provides a public proof of ownership or certificate of authenticity to owners of an NFT. The digital signature allows for verifiable transferability from one owner to another, and sales or trades of NFTs has become increasingly popular. Typical NFTs may include art, music, trading cards, signatures, memes, collectables, and the like.

As described herein, a “smart contract” is a computer program that is capable of automating execution of the terms of a machine-readable contract based on rules that can process inputs in order to produce results, which can cause actions to be performed that are dependent on these results. Generally, smart contracts are used in the transfer of property rights or assets including, for example, digital assets such as NFTs. In particular, each NFT may be associated with a programmatically defined smart contract written to a respective blockchain ledger. According to various embodiments described herein, the smart contracts may include specified fee distribution obligations, such as licensing royalties, that are recorded in the blockchain.

As disclosed herein, the terms “mint,” “minted,” “minting,” and the like refer to a process of generating of digital assets on a blockchain. In particular, a token (e.g., an NFT) is minted when digital data is converted into a digital asset and recorded/stored in a blockchain.

The disclosed systems and methods provide access-controlled, private, multi-document NFTs for any blockchain distributed ledger including, for example, Ethereum, Bitcoin, Bitcoin Satoshi Vision (BSV), Polygon, and the like. In particular, disclosed herein is a computing system for encryption using blockchain distributed ledgers. The system includes a memory and one or more processors in communication with the memory. The system also includes program instructions that are executable by the one or more processors via the memory. Execution of the program instructions encrypts, via a symmetric key, multiple documents to be incorporated into a single non-fungible token (NFT), and generates a data file that includes a portfolio array of links to each encrypted document of the multiple encrypted documents. Further, execution of the program instructions executes a mint function to create the single NFT on a blockchain, where the single NFT includes a link (i.e., a tokenURL) to the generated data file. Additionally, execution of the program instructions transmits the single NFT to a digital wallet of the blockchain.

Advantageously, the systems and methods disclosed herein allow for multiple documents, including, for example, documents that provide proof of ownership, to be included in the same NFT, thereby eliminating the need for minting separate a separate NFT for each document. Additionally, the systems and methods disclosed herein provide for controlled access to an NFT.

In particular, according to one embodiment, a host computer system and metadata specification are disclosed that extend the functionality of a standard Ethereum NFT, thereby facilitating the inclusion of additional documents that are protected and access-controlled, whilst enabling new portfolio NFTs with a new specification to be backward compatible. This backwards compatibility allows for portfolio NFTs to still be supported on older NFT exchanges. The systems and methods disclosed herein would be portable to any blockchain, thereby extending the usability of the Ethereum NFT to other blockchains. The ability to include additional documents enables a user (i.e., minter) minting a portfolio NFT to include a proof of purchase or certificate of authenticity, or even an image of the back or sides of a physical artwork, to prove that the user has actual custody of the work being minted. The minter can even include additional material to enhance the value of the portfolio NFT, such as the artist's narration of the artwork.

An example host computer system is disclosed for transacting with NFTs on one or more blockchains. This system includes a processor, a network interface device connected to the processor, a computer readable medium connected to the processor, a data store on the computer readable medium and a set of instructions on the computer readable medium that are executable by the processor. The set of instructions includes a login module, a user module, an NFT management module connected to one or more transaction modules each configured for a specific blockchain, a plurality of wallets managed by the user module, a document gateway which connects to a local or remote computer readable medium to store, retrieve and render encrypted document files referenced by the portfolio NFT, controlling access to said documents, a website, having a user interface, which communicates with a plurality of user devices, and an application programmable interface (API) for accepting communication with a third-party host computer application.

According to one embodiment, the user module accepts, via the website user interface, communication from an individual on a user device to register as a new user and supply user and password information. Once registered, a login module accepts the login request from the user, matching the supplied credentials with those stored by the user module in the computer readable medium. The user module also manages the establishment of a user's digital wallets, which are accessed by the NFT management module to mint new portfolio NFTs which are deposited in the user's wallet. The digital wallets may, according to one embodiment, ask the user to confirm and approve of a minting transaction.

According to one embodiment, the user interacts with the NFT management module via a website user interface to transfer NFTs into and out of a user wallet. Further, the NFT management module can be used to mint new portfolio NFTs as well as regular NFTs on any supported blockchain. These portfolio NFTs are minted, by the NFT management module, via smart contracts that the management module has deployed on the blockchains. Further, the NFT management module communicates with a document gateway to store the documents associated with the NFT, and instructs the document gateway to create a symmetric encryption key used to encrypt all documents of the portfolio NFT. This symmetric encryption key is then further encrypted by the private key of an asymmetric key pair belonging to the minter (generated and managed by the user module). This encrypted symmetric key can be stored on a computer readable medium (such as the NFT cache), or on the NFT itself

According to various embodiments, another individual inspecting the public NFT would find the document links therein pointing to the document gateway with a unique identifier for the document. The document gateway, without the correct authentication details, would return a low resolution and/or watermarked version of the requested document—or none at all, depending on how the owner configured the access controls for the NFT documents. For example, if the NFT includes an electronic document (e.g., a document in Microsoft Word, a PDF, etc.) or an image (e.g., a photograph, digital image, etc.) the preview may include a watermarked version of the first page of the electronic document or image, and if the NFT includes an audio/video file the preview may include a low-resolution audio/video file for the first fifteen seconds. If the external_url for the document was used (requesting the webpage for the document), the document gateway would present the same results, but would also include a log in or register user option. If a user was logged in (or valid user authentication details were included in the request), and the user was authorized by the minter/owner to decrypt the document, the full unencrypted document would then be rendered. Alternatively, a visitor could register, after receiving an invite email from the minter/owner. Upon registration, the user module would assign the public document key to the visitor's user account, which would thus enable the document gateway to decrypt the symmetric key and thus decrypt the NFT documents. The owner of an NFT initiates the process of inviting a visitor by requesting the user manager send an invite request via email.

Further, according to various embodiments, a minter/owner transfers the portfolio NFT to another individual, the encrypted symmetric key stored at the document gateway is no longer valid. The document gateway looks up the encrypted symmetric key in the computer readable medium and identifies that the NFT owner address stored with the key is no longer the same as the current owner address. The document gateway communicates with the NFT management module which communicates with the blockchain to verify a transfer occurred for the NFT and that the current owner address is registered to the current logged in user. If so, the document gateway loads the old private document key stored in the computer readable medium associated with the NFT, derives the public document key from the private key, decrypts the symmetric key, and re-encrypts the symmetric key by using the private document key for the new owner. This new encrypted symmetric key for the new owner overwrites the old encrypted symmetric key on the computer readable medium, allowing the new owner to access and view the NFT documents, and disallowing the previous owner from doing so.

According to various embodiments, more fine-grained access controls, such as a time limit for the viewing privileges, per document permissions, or resolution downgrading, etc., could be presented to the minter by the NFT management module, and the preferences could be stored in the computer readable medium and enforced by the document gateway.

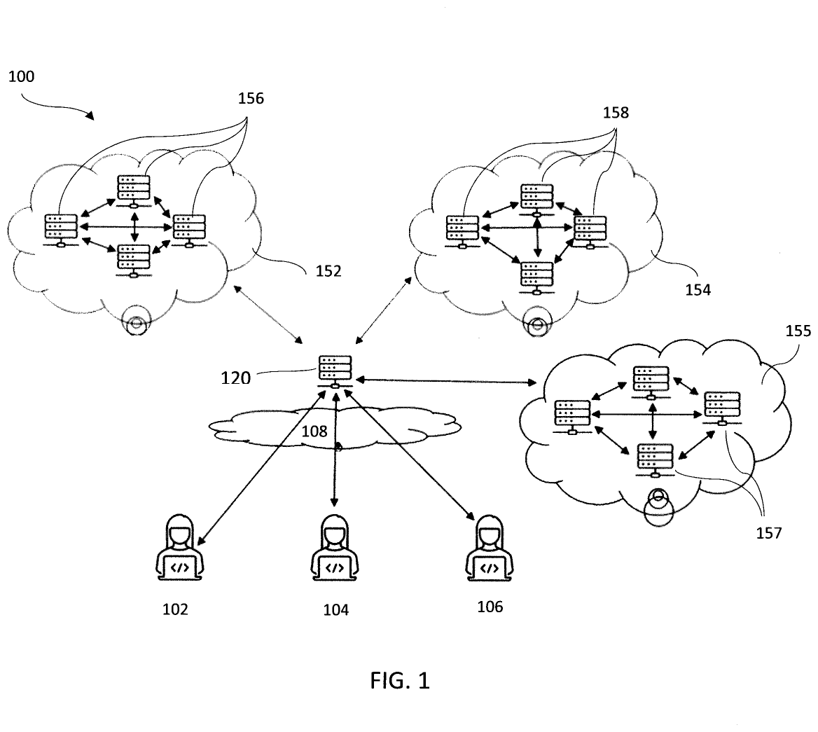

FIG. 1 depicts an example computing environment 100 that includes blockchain node networks 152, 154 and a file system network 155, according to an implementation of the present disclosure. Also depicted is a first host computer system 120 (which could be one of many), and user devices 102, 104, 106, which connect to the host computer system(s) 120 via the internet 108. The first host computer system(s) 120 connect with the blockchain nodes 156 and 158 considered the host nodes of the respective blockchain node networks 152, 154. Each respective node 156, 158 in the blockchain networks 152, 154 is interconnected to several other nodes of that respective blockchain node network 152, 154, forming a fault-tolerant peer-to-peer network. Should a host node become unavailable, the host computer system 120 would connect to an alternate node within the blockchain network 152, 154.

Various embodiments of the present computer system(s) 120 can be implemented within computing environment 100. According to one embodiment, a host computer system 120 may include various computing devices or a singular host computing device. By way of example, host computer system 120 may act as a data source that executes program code that transmits data to any number of computing devices 102, 104, 106.

According to one embodiment, a first host computer system 120 may also connect to the file system network 155 such as, for example, InterPlanetary File System (IPFS), to store encrypted document files and NFT metadata. The file system network 155 may, according to various embodiments, be any protocol, hypermedia and file sharing peer-to-peer network for storing and sharing data in a distributed file system. According to one embodiment, each storage node 157 in the file system network 155 is interconnected with other storage nodes 157, providing redundancy and fault tolerance for the file system network 155.

As illustrated, computing device 102, computing device 104, and computing device 106 are different computing devices that may be in communication across one or more network(s) 108. For example, the network(s) 108 may be wired or wireless and may include a telecommunications network, a local area network (LAN), a wide area network (WAN) such as the Internet, or a combination thereof. Further, the network(s) are capable of transmitting data that can be received by one or more of the various computing devices 102, 104, 106.

Computing device(s) 102, 104, 106 may execute program code that is configured to perform methods in accordance with one or more aspects of the present invention. The various computing devices 102, 104, 106 may include one or more processors (e.g., central processing units CPUs) and various functional components to integrate program code by fetching, decoding, and executing the program code. The various computing devices 102, 104, 106 can include memory, input/output, a network interface, storage, and other computing components, that can be coupled to each other via one or more buses and/or other connections. According to various embodiments, the computing devices 102, 104, 106 may include or be associated with specific e-commerce websites, organizational websites, software applications, etc. that provide capabilities for initiating the transactions disclosed herein. Examples of computing devices include, but are not limited to, smartphones, tablet computer devices, laptop computing devices, personal computing devices, smart televisions, gaming consoles, and the like.

The host system 120 may include one or more graphical user interface accessible via the computing devices 102, 104, 106 that may allow a user to offer items (e.g., NFTs) for sale and or purchase, e.g. using cryptocurrency and/or a credit card, items (e.g., NFTs). According to some embodiments, the system 120 includes an application programming interface (API) system that expose APIs to one or more related applications or third party systems that are supported by or otherwise interact with the system 120.

In various embodiments, the system 120 may support a digital wallet that stores tokens owned by a user. The user has at least one digital wallet, although the user may have multiple digital wallets with each digital wallet being associated with different blockchains, and the system connects to the digital wallet of the user to get the wallet address. Various embodiments of the system 120 may include intelligence and automation functionalities that perform machine learning and artificial intelligence tasks to train machine learned models, make classifications and predictions, recommend products to users, etc. Various embodiments may incorporate analytics reporting to facilitate improvements to the system 120.

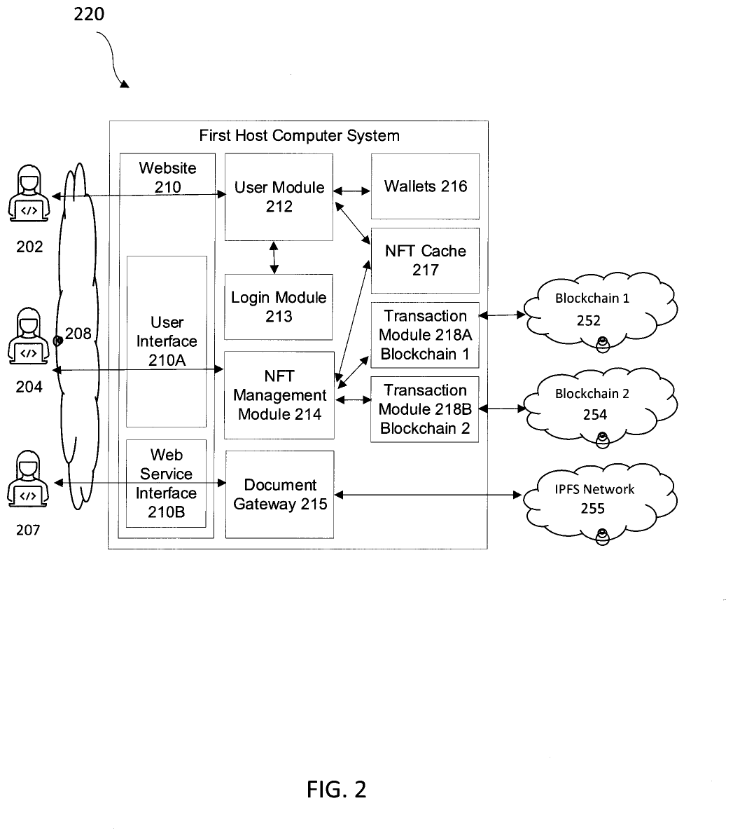

FIG. 2 depicts a block diagram of an example computing system 220 for encryption using blockchain distributed ledgers, according to an implementation of the present disclosure. The computing system 220 of FIG. 2 may, according to various embodiments, be included in host computing system 120 depicted in FIG. 1.

Referencing computing system 220, included therein is a website 210 that includes a user interface 210A and a web service interface 210B (e.g., an application programmable interface (API)). A login module 213 and a user module 212 are associated with the website 210, where the user module 212 manages one or more user wallets 216 associated therewith. Also depicted is an NFT management module 214 that is associated with the web site 210 and that includes a number of transaction modules 218A, 218B. Each transaction module 218A, 218B is configured to connect to a specific blockchain 252, 254, thereby enabling the NFT management module 214 to connect and transact with each supported blockchain. The NFT management module 214 also includes a one or more NFT cache objects 217 for each respective user wallet 216. Each NFT cache object 217 represents a user's NFT that is stored on one of the blockchains 252, 254.

Additionally, as depicted in FIG. 2, the computing system 220 also includes a document gateway 215 that manages communication with file system network 255 such as, for example, InterPlanetary File System (IPFS). The document gateway 215 facilitates storage and retrieval of the multiple encrypted documents included in the file system network 255. Additionally, document gateway 215 may also store and retrieve data files, e.g., metadata.json files, which are included in the generated data file that includes a portfolio array of links to each encrypted document.

The web service interface 210B allows a third party host computer system 207 to request access to an encrypted document or to create a single NFT that includes a link to a data file that includes the portfolio array of links to each encrypted document. The third party host computer system 207 uses software code on the third party host computer system 207 to communicate with the first host computer system 220 via the web service interface 210B.

User devices 202, 204 connect, via the internet, to the website 210 using the user interface 210A. A user using user device 202, 204 may use the user module 212 to access the login module 213 to log in, thereby obtaining access to the various functionalities of the first host computer system 220 including, for example, the NFT management module 214 or the document gateway 215.

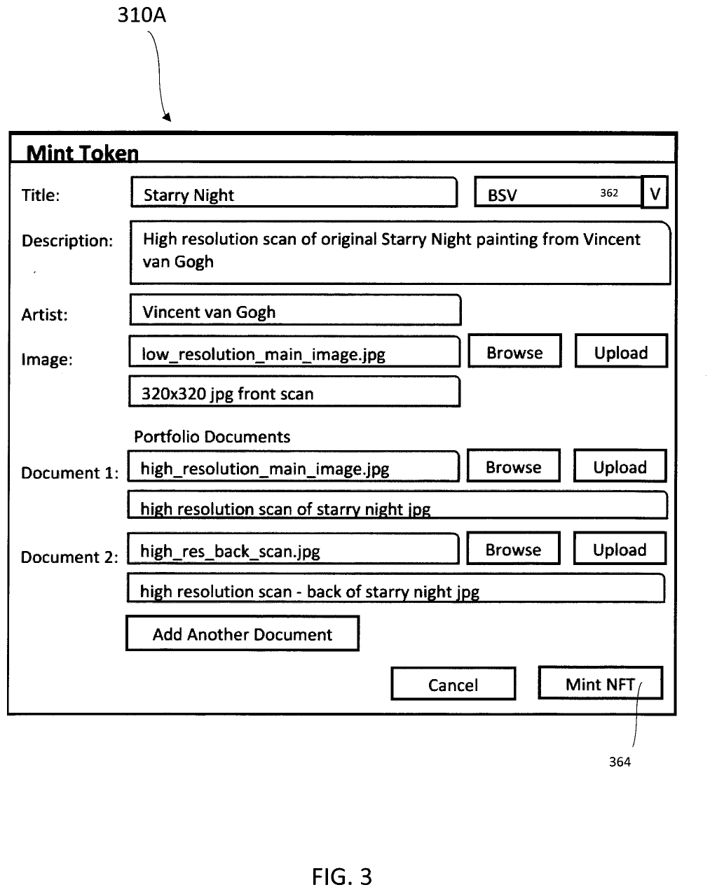

FIG. 3 depicts an example user interface 310A visible via a computing device, according to an implementation of the present disclosure. In particular, the example user interface 310A includes a web page provided by the user module (such as user module 212 of FIG. 2) that would be displayed via a user interface of a computing device (such as user device 202, 204 of FIG. 2). The example user interface 310A may enable a user that is logged in to the user module request that the first host computer system (such as first host computer system 220 of FIG. 2) executes a mint function to create a single NFT on a blockchain, where the single NFT includes a link to the generated data file that includes a portfolio array of links to each encrypted document.

According to one embodiment, a user may use the example user interface 310A to select multiple documents that are stored on a user device (such as user device 202, 204 of FIG. 2) that the user wants included on an NFT. The user may upload, via the user interface 310A, each document to be included on the NFT. Further, the user interface 310A may be used to specify the desired blockchain where the NFT is to be minted, and once all necessary parameters are selected and the desired documents are uploaded the user may select the “Mint NFT” button 364 so that the first host computing system (such as first host computing system 220 of FIG. 2) will execute, via the NFT management module (such as NFT management module 214 of FIG. 2), the mint function to start the minting process and create the single NFT on the blockchain.

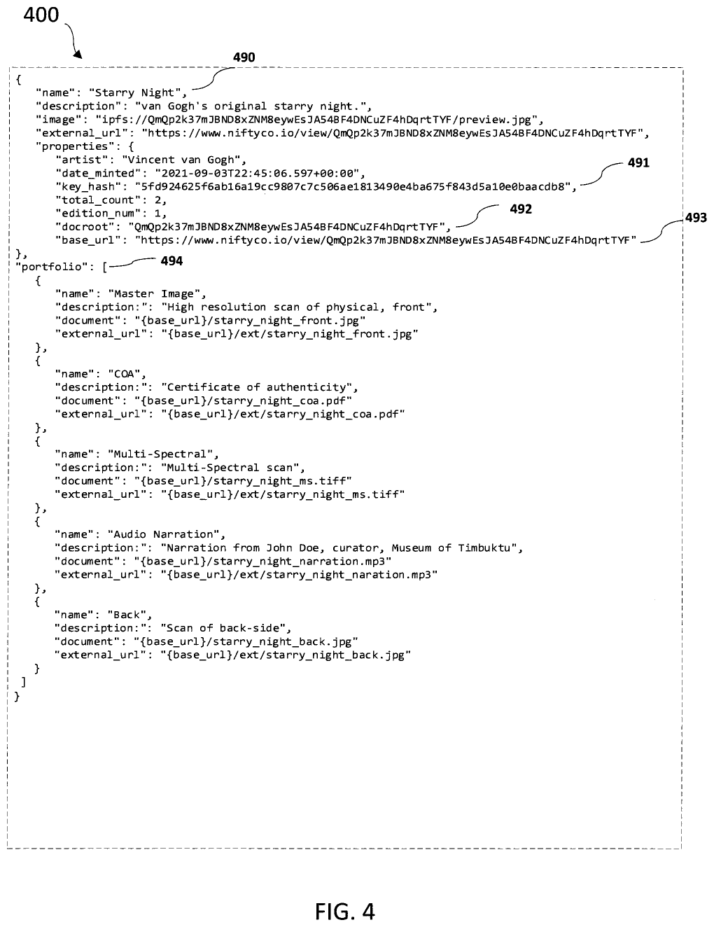

FIG. 4 depicts an example data file 400 that includes NFT properties and portfolio properties for multiple documents, according to an implementation of the present disclosure. According to one embodiment, the example data file 400 is a non-limiting example that includes a metadata.json file that is a metadata file that is utilized for Ethereal NFT contracts that is modified to include a portfolio array object 494. The portfolio array object 494 enables standard Ethereum NFT contracts to include multiple related documents that can be transferred from one wallet to another in a single transaction via a single NFT 490. According to one embodiment, each portfolio array object 494 may include a document name, a description, a direct uniform resource locator (URL) link to the encrypted document(s), and an external URL to access the document webpage. An example document webpage may enable a user to log-in/register (with invite) to access the full unencrypted document(s).

Additionally, the example data file 400 is a metadata file that may include a key_hash 491 property, which is the hash of a symmetric key that is used to encrypt the documents of the newly minted NFT 490. As contemplated herein, the key_hash 491 would not the symmetric key, but would rather be a SHA256 hash or similar of the symmetric key that would be used to verify that the symmetric key that is supplied for a future decryption process matches what was used to encrypt the documents of the newly minted NFT. Furthermore, the example data file 400 includes an identifier of the document storage location for the NFT documents, where the identifier is stored under the property “docroot” 492, and the URL link to this document storage location is indicated as “base_url” 493.

According to one embodiment, the example data file 400 would be blockchain agnostic such that the portfolio NFTs may be minted onto any blockchain that includes smart contracts and that is designated by a user. In the example provided herein, the metadata.json specification may include smart contracts that utilize the same or a similar metadata format pointed to by a tokenURL or equivalent property.

Various modifications of the example data file 400 depicted are also contemplated herein. For example, according to one embodiment, the data file 400 may omit the “base_url” 493 or other aspects of the data file 400.

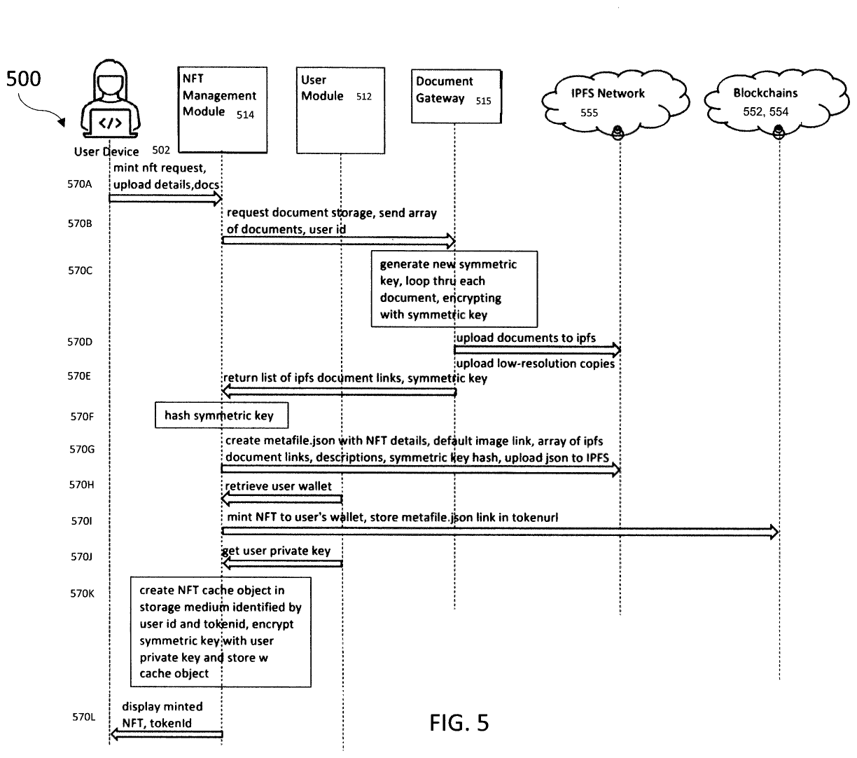

FIG. 5 depicts an example sequence diagram 500 for creating an NFT, according to an implementation of the present disclosure. In particular, the example sequence diagram 500 depicts interactions between a user device 502, various modules of a host computer system (such as first host computing system 220 of FIG. 2), and various blockchain node networks 552, 554 and a file sharing network 555 (e.g., IPFS). The NFT created by the example sequence would be a single NFT that includes a link to a data file that includes a portfolio array of links to each encrypted document.

As depicted by example sequence diagram 500, the user device 502 may perform a step 570A of communicating with an NFT management module 514 (after a user has successfully logged in), where the information communicated, via step 570A, to the NFT management module includes the NFT properties and the specific documents that are to be included in the new NFT. At step 570B, the NFT management module 514 sends, based on receiving the information communicated via step 570A, an array of documents and the user ID to the document gateway 515. At step 570C, the document gateway 515 generates a new symmetric key for the new NFT documents, and iterates through each document that is to be included in the NFT and encrypts each document with the same symmetric key. Further, at step 570D, both the encrypted versions of the documents as well as an unencrypted version of the documents, where the unencrypted versions are variations of the encrypted documents, are stored onto the file sharing network 555. According to various embodiments, the unencrypted version of the documents include variations of the multiple encrypted documents, where the variations include at least one selected from (a) a low-resolution version of the encrypted documents and/or (b) a watermarked version of the encrypted documents. In various embodiments, the variations may include only a single low-resolution version of one or more of the encrypted documents. Alternatively, the variations may include multiple low resolution versions of a plurality or each of the encrypted documents. In other embodiments, the variations may include both a low-resolution version of one or more of the encrypted documents and a watermarked version of one or more of the encrypted documents. Also possible, the variations may include a single watermarked version of one or more of the encrypted documents, or the variations may include a watermarked version of a plurality or each of the encrypted documents. Various other combinations of the variations are also contemplated herein. Advantageously, the variations of the multiple encrypted documents provide a layer of privacy, such that not everyone with the ability to find the NFT would be able to access the documents.

Based on completion of step 570D, the document gateway 515 returns, in step 570E, the symmetric key and the URL for each encrypted document, as well as the variations of the multiple encrypted documents, back to the NFT management module 514. The NFT management module 514 creates, in step 570F, a hash of the symmetric key, and in step 570G the NFT management module creates and uploads to the file sharing network a data file (e.g., a metadata file such as a metadata.json object) with the document URLs, NFT properties, and the hash of the symmetric key. At step 570H, the NFT management module 514 retrieves the user wallet from the user module 512, and at step 5701 the portfolio NFT is minted onto one of the blockchains 552, 554, specifically a blockchain identifies by the user. In particular, at step 5701, the NFT is minted to the user's wallet on the desired blockchain, and also stored therein is a tokenURL link set to the data file (e.g., a link to the metadata.json URL that is on the file sharing network). At step 570J, the user's private key is retrieved from the user module 512, and the private key is used, at step 570K, by the NFT management module 514, to encrypt the symmetric key. Also at step 570K, an NFT cache object is created in a computer-readable storage medium that is identified by the user ID and the NFT token ID. At step 570L, the minted NFT along with its new token ID is provided to the user device 502 and may be displayed, via a user interface of the user device 502, to the user.

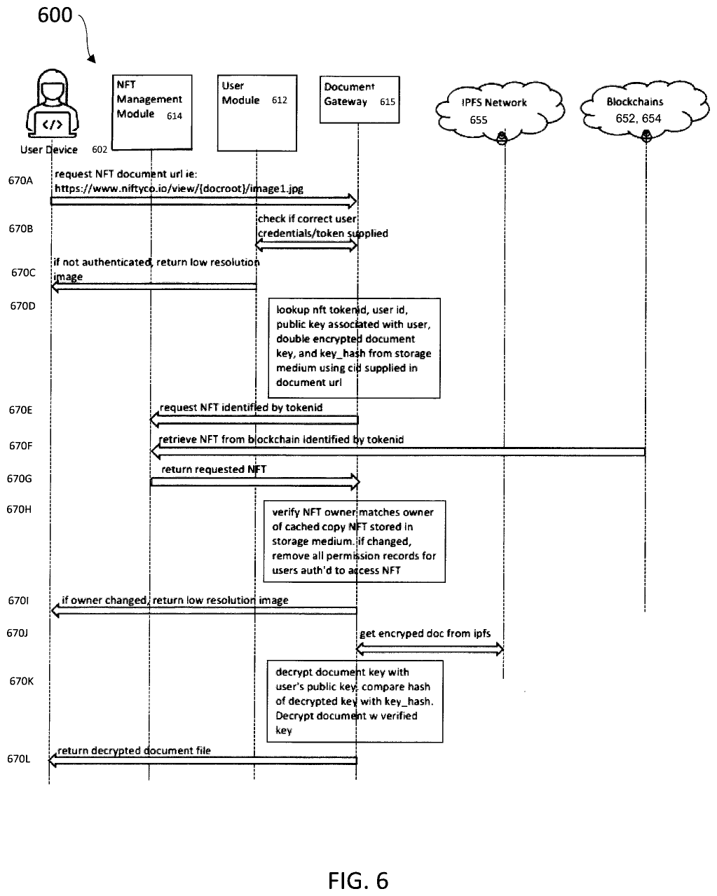

FIG. 6 depicts an example sequence diagram 600 for accessing encrypted documents via an NFT that includes a link to a data file, according to an implementation of the present disclosure. In particular, the sequence diagram 600 depicts steps that may be performed by a first host computer system (such as first host computing system 220 of FIG. 2) when a request is received by the first host computer system and from a user device 602 to display a secure NFT document via the user interface of the user device 602. Additionally, or alternatively, the example process depicted by sequence diagram 600 may also be used by a third-party host computer system so that a secure NFT document may be displayed. At step 670A, a user device 602 may send a request to the document gateway 615 to view a secure NFT document. The document gateway 615 checks, at step 670B, the user authentication credentials provided by the request against the user authentication information at the user module 612. For example, this check may determine whether the request was made by a user who has logged in, via the user module 612, and therefore provided the correct user authentication data. Additionally, this check may also determine whether the correct authentication data is supplied in order to decrypt the encrypted documents and provide the user device with the decrypted documents. At step 670C, based on determining that the user credentials are incorrect or that the user is not logged in, the user module 612 provides an unencrypted version of the documents that has been stored on the file sharing network 655 (e.g., IPFS), where the unencrypted versions are variations of the encrypted documents that include a low-resolution version of the encrypted documents and/or a watermarked version of the encrypted documents.

If, however, it is determined from step 670B that the user credentials provided are accurate and the user is logged in (e.g., the user device 602 is registered on the host computer system as belonging to the user that has authorization to access the encrypted documents or the user supplied a unique registered device ID and an authentication token), then at step 670D the document gateway 615 performs a lookup (e.g., using the docroot property embedded in the requested document URL) of the NFT token ID, the document public key associated with the user ID and the token ID, and the encrypted symmetric key. This lookup may access, for example, an NFT cache object that is stored via a computer-readable storage medium and that is identified by the user ID and the NFT token ID that was provided by the request at step 670A.

At step 670E, the document gateway 615 sends a request for the single NFT that includes a link to the generated data file to the NFT management module 614. At step 670F, and based on receiving the request of step 670E, the NFT management module 614 communicates with the blockchain 652, 654 and retrieves, from the blockchain 652, 654, the NFT that was identified by the token ID. At step 670G, the NFT management module 614 returns the NFT to the document gateway 615. Once the NFT is received by the document gateway 615, the document gateway 615 performs step 670H, to verify that the owner wallet address in the NFT matches the information that was stored in the NFT cache. If during the verification step 670H it is determined that the owner wallet address does not match the information that was stored in the NFT cache, it is presumed that the ownership of the NFT has changed and that the current user that submitted the request at step 670A no longer has access to the NFT. Based on determining that there is not a match during the verification step 670H, the document gateway 615 removes all permission records matching the NFTs token ID and at step 6701 the document gateway 615 redirects the user to the unencrypted version of the documents that include variations of the encrypted documents (e.g., a low-resolution version of the encrypted documents or a watermarked version of the encrypted documents).

Alternatively, if the document gateway 615 determines during step 670H that the wallet address matches the information that was stored in the NFT cache then at step 670J the encrypted document is retrieved from the file sharing network 655. Based on obtaining the encrypted document at step 670J, the document gateway 615 decrypts, at step 670K, the encrypted symmetric key by using the user's public document key, hashes the decrypted key, and then compares the hash of the decrypted key with the key_hash that is stored in the NFT cache. If step 670K is unable to verify that the hash of the decrypted key matches the key_hash that is stored in the NFT cache, then an error is returned to the user device 602. Alternatively, if step 670K determines that the decrypted key is a match with the symmetric key that originally encrypted the documents, then the document gateway 615 performs step 670L and decrypts the encrypted document file and returns the decrypted document file to the user device 602.

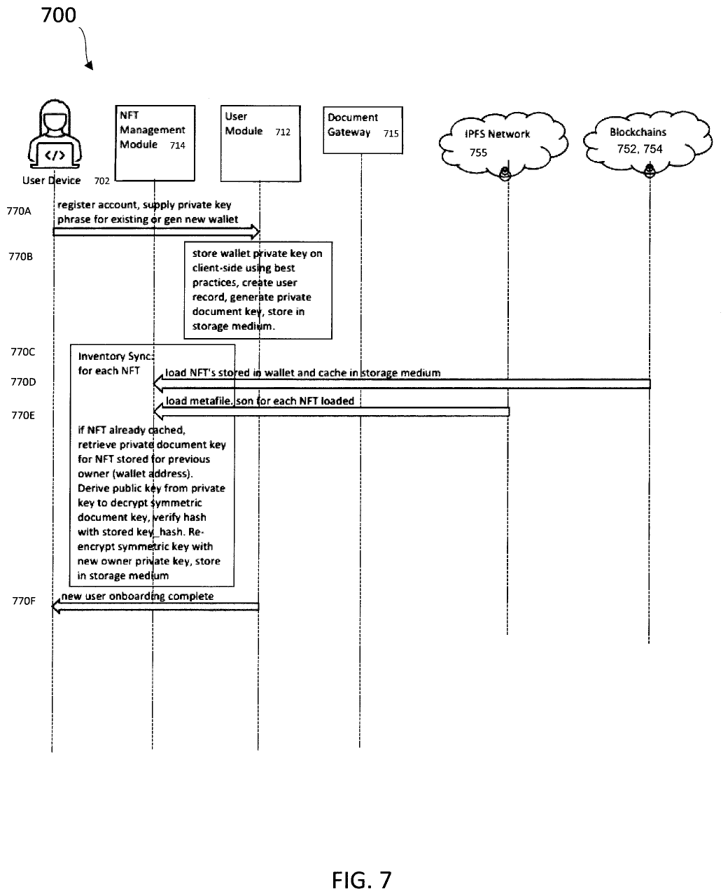

FIG. 7 depicts an example sequence diagram 700 for registering a new user to have access to encrypted documents using an NFT that includes a link to a data file, according to an implementation of the present disclosure. In particular, the sequence diagram 700 depicts steps performed by a first host computer system (such as first host computing system 220 of FIG. 2) to register a new user and onboard an NFT to the user's wallet.

At step 770A, a user module 712 may receive a request from a user device 702 to register a new user, and based thereon the user module 712 may create a new user account record on a computer-readable storage medium and register the user's existing wallets and/or generate new wallets for the requested blockchains 752, 754. At step 770B, the user module 712 may store private keys for the user wallets and generate a private document key for the user. According to one embodiment, the private document key may be stored on a computer-readable storage medium.

At step 770C, the NFT management module 714 may communicate, via a transaction module (e.g., such as transaction modules 218A and 218B of FIG. 2) configured for a specified blockchain 752, 754, with the specified blockchain 752, 754 to retrieve the NFTs stored in the user's wallet for that specified blockchain 752, 754. At step 770D, each NFT retrieved from the user's wallet in step 770C is stored in an NFT cache on a computer-readable storage medium. As contemplated herein, if the NFT cache record for the token ID of the NFT already exists, this likely indicates that this NFT was previously transferred to another wallet and that the encrypted symmetric key is no longer valid, in which case all permission records matching this token ID are deleted. Further, as part of step 770D, if the NFT cache record for the token ID of the NFT already exists the document gateway 715 may retrieve an existing private key stored in the computer-readable medium of the user that owns the wallet that was previously attached to the NFT. According to one embodiment, the public key may be derived from the private key and used to decrypt the encrypted symmetric key already stored in the NFT cache to obtain the symmetric key.

At step 770E, the document gateway 715 may retrieve a data file (e.g., a metadata.json file) from a file sharing network 755 (e.g., IPFS) and compare the key_hash stored thereon against the decrypted symmetric key to ensure the key_hash matches the decrypted symmetric key. Further, the document gateway 715 encrypts the symmetric key with the new owner's private document key and stores the new encrypted symmetric key in the NFT cache of the current NFT. If the data file does not exist or if the key_hash property is not present, then the loaded NFT may not include a data file including a portfolio array of links to encrypted documents, but such NFT would still be cached and supported. At step 770F, once all NFTs owned by the user have been iterated through, the new user registration process is complete and the user module 712 redirects the user interface of the user device 702 to the logged-in user's home page.

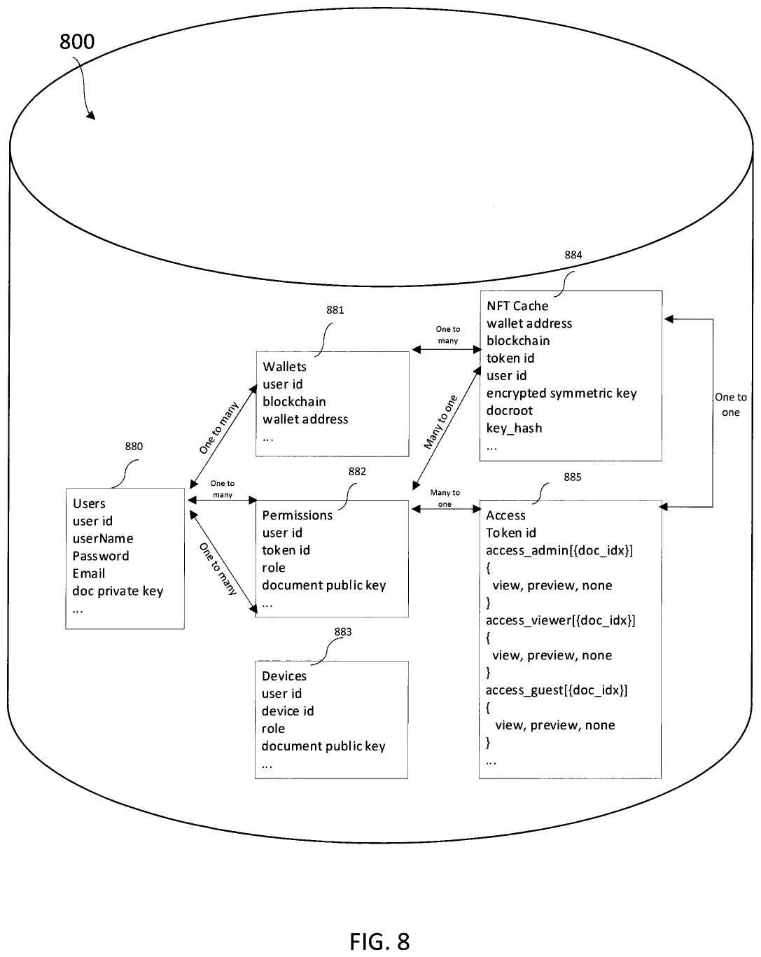

FIG. 8 depicts an example diagram of a database 800 that is used by a host computing system, according to an implementation of the present disclosure. In particular, the database 800 includes basic data tables and fields, would utilize the computer-readable storage medium, and would be used by components (e.g., the user module, login module, NFT management module, and document gateway) of the first host computing system. This database, or portions thereof, may be located at the host computer system, on the cloud, or on a blockchain.

The example user table 880 may be configured to store user information for each user of the first host computing system (such as first host computing system 220 of FIG. 2). For instance, the user information that is stored may include user ID, username, email, password, etc. Additionally, according to one embodiment, each user record stored in user table 880 may also include a document private key, which is generated for each user. In other embodiments, the database 800 would not store the document private key if, for example, the document private key is the user's wallet private key or a variation thereof. The document private key may be used when a new NFT is minted and the NFT documents are encrypted.

The database 800 may also include a wallet table 881 that stores references to one or more registered wallets of each user. The wallet table 881 may include the user ID, the public address of the wallet, and a reference to the blockchain on which the wallet resides. According to one embodiment, the reference to the blockchain stored by the wallet table 881 includes a numeric value (unique identifier) to represent text (e.g., a hardcoded number), or include an enumerator, or a record ID, where the record ID includes a network ID of the blockchain. In one example reference to the blockchain, a network ID for Ethereum Virtual Machine blockchains may be used (i.e., using 1 for Ethereum, 137 for Polygon), and using defined, hardcoded constants may be used to represent, for example, SOLANA. Private wallet keys may be stored via various processes including, for example, by being encrypted by a server-side key and stored within an HttpOnly cookie on a client device, which cannot be accessed via malicious javascript. Further, according to one example, the private wallet keys may not be stored on a host computer system to provide added protection in case the host computer system becomes compromised.

The database 800 may also include a plurality of permission records 882. According to one embodiment, each user may have a plurality of permission records 882, with each NFT that the user has been granted access, but does not own, having a permission record associated therewith. Each of the permission records 882 may indicate a specified role that was granted to the user by the NFT owner, and each of the permission records 882 may also hold a public document key to be used in the decryption process.

The database 800 may also include device records 883. Each user may have one or more computing devices that are registered to the user's account and identified by a unique device ID. The computing devices may include, for example, mobile devices, stream casting devices (e.g., a Chromecast™ device, an AMAZON FIRE® device, a ROKU® device, a smart TV device, or various other devices). The computing devices may connect to the host computer system using device ID and/or an authentication token without requiring a username and/or password. A user using an authenticated computing device may have access to all user documents for which the computing devices are authorized to access, which depends on the authorization role assigned to the specific computing devices.

The database 800 may also include an NFT cache record 884, although various implementations of the disclosed systems and methods may utilize a cache record in an on-chain database (i.e., a blockchain-based database) or a smart contract. A cache record, such as NFT cache record 884, may include a unique identifier of each NFT owned by all registered users across all supported blockchains. In particular, the cache record 884 may include, according to various embodiments one or more of the following: a user ID, a wallet address of the digital wallet, a unique identifier of the NFT including a blockchain identifier identifying both the blockchain and an NFT token ID of the single NFT, contract address, and an encrypted symmetric key. According to various embodiments, the unique identifier is a docroot identifier.

According to various embodiments, the database 800 may also include an access table 885, where the access table 885 defines specific access rights for each NFT such as, for example, different roles associated with specific document. For instance, the access table 885 may indicate whether a document at index 1, 2, 3, etc. can be viewed, previewed, or if viewing is to be prevented.

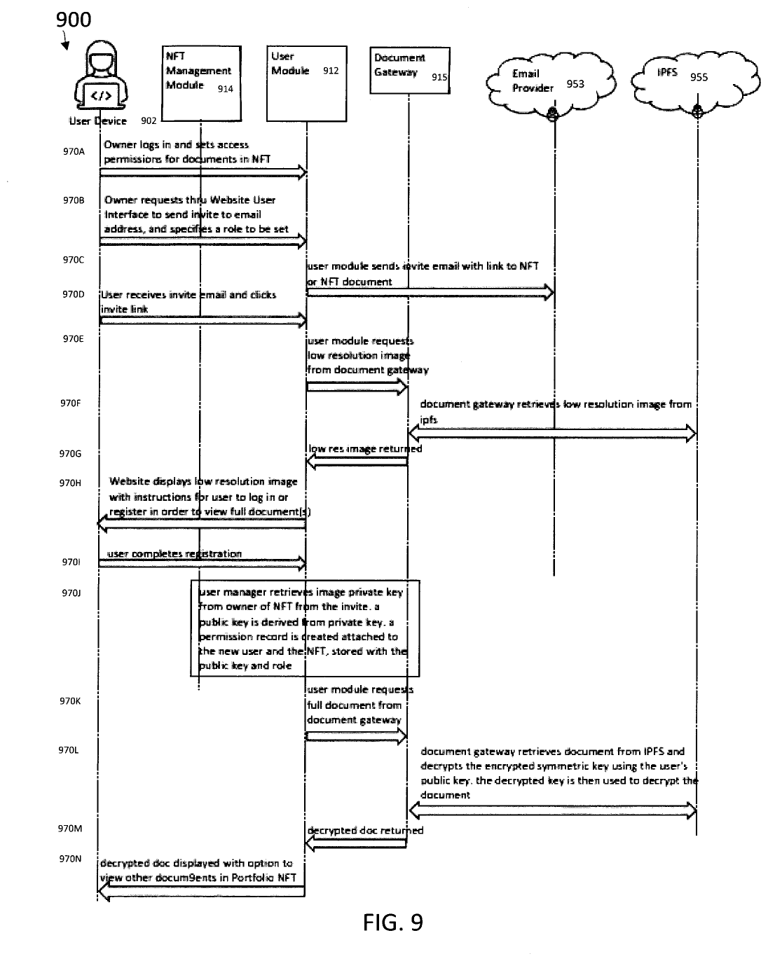

FIG. 9 depicts an example sequence diagram 900 for authorizing an additional user to access encrypted documents via an NFT that includes a link to a data file, according to an implementation of the present disclosure. Contemplated herein is a process for an owner of an NFT to selectively invite one or more users to have access to one or more documents within the owner's NFT. At step 970A, a logged-in NFT owner may set access permissions for one or more documents with one of the owner's NFTs. In particular, the owner may utilize a user device 902 to access, via a user interface (e.g., accessed via the internet), a user module 912 to set the access permissions for various documents within the NFT. According to one embodiment, step 970A may allow additional user(s) to have various roles that are associated with each document in the NFT such as, for example, allowing an additional user to view an unencrypted document, view a low-resolution version of the document, view a watermarked version of the document, or alternatively prohibit the additional user from having any access to the document. According to various embodiments, a default setting for each document may provide access to each invited user to fully view each document.

At step 970B, the owner can request that the host computing system send an electronic communication (e.g., an email, text, etc.) to be sent to a user, where the electronic communication includes an invite granting access to the role specified by step 970A for a specific NFT and/or one or more documents within the NFT. According to one embodiment, once the user module 912 receives the request to send the electronic communication, the electronic communication may be created and sent via an email provider 953.

At step 970D, once the electronic communication has been sent, the recipient user may select an invitation link provided by the electronic communication to access a website user interface provided via the user module 912. At step 970E, the user module 912 requests a low resolution image of an NFT document from the document gateway 915. At step 970F, the document gateway 915 retrieves a low-resolution image of the NFT document from a file sharing network 955 (e.g., IPFS). At step 970G, the document gateway 915 may provide the low-resolution image of the NFT document to the user module 912.

At step 970H, the website user interface may provide, according to one example, a low-resolution image of the NFT document with instructions directing a user to log in and/or register in order to view the full document. According to various embodiments, the low-resolution image that is displayed via the website user interface may be accompanied by a login button, a register button, and/or instructions for the user to login or register to access the document(s).

At step 970I, a user may input, via the user device 902, various information to register a new account based on, for example, the user being a new user. At step 970J, the user module 912 identifies the NFT associated with the new account and retrieves the user private document key from the owner account of the NFT. Further, the user module 912 derives a public document key from the private document key of the owner account and creates a permission record for the user/NFT pair that includes the public document key and also includes the user's role. At step 970K, the document gateway 915 submits a request to retrieve the encrypted document from the file sharing network 955. At step 970L, the document gateway 915 retrieves the encrypted document from the file sharing network 955 and retrieves, e.g., via the NFT management module 914, the encrypted symmetric key from the NFT cache. Further, at step 970L, the document gateway 915 decrypts the symmetric key using the public document key and decrypts the document with the symmetric key after verifying, e.g., via the NFT management module 914, that the hash of the symmetric key matches the stored key_hash in the NFT cache.

At step 970M, the decrypted document is provided by the document gateway 915 to the user module 912, and at step 970N the user module provides, via the webpage, the user device 902 with a rending of the document, and may be accompanied by options to view one or more other documents on the NFT.

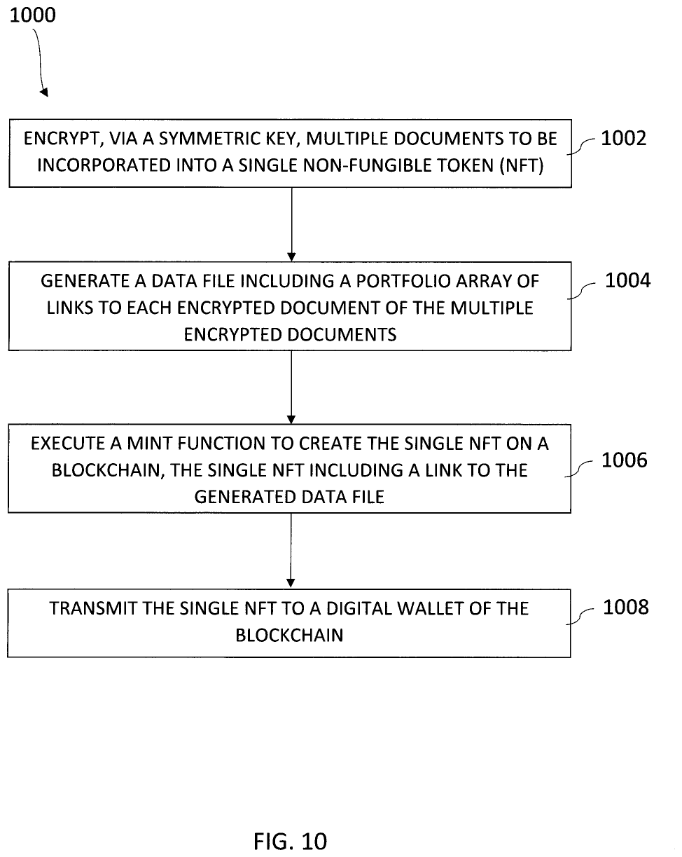

FIG. 10 depicts an example method 1000 for encrypting documents on a single NFT, according to an implementation of the present disclosure. In step 1002, execution, via one or more processors, of program instructions encrypt, via a symmetric key, multiple documents to be incorporated into a single NFT. In step 1004, a data file is generated that includes a portfolio array of links to each encrypted document of the multiple encrypted documents. In step 1006, a mint function is executed, where the mint function creates the single NFT on a blockchain, and the single NFT includes a link (i.e., a token URL) of the generated data file. Further, in step 1008 the single NFT is transmitted to a digital wallet of the blockchain. The digital wallet may include a cryptographic, key-based digital wallet. Although not shown, the method 1000 may also include additional steps such as, for instance, encrypting the symmetric key with a document private key of a user and storing the encrypted symmetric key in an NFT cache. Advantageously, the method 1000 creates a single NFT on a blockchain that supports multiple access-controlled documents, thereby limiting access to the document contents to authorized users.

According to one embodiment, step 1002 is initiated based on receiving, via a user interface of the host computing system, a request from a logged-in user to create an NFT that includes multiple documents uploaded by a user. Additionally, according to one embodiment, the method 1000 includes uploading both the encrypted documents encrypted in step 1002 and unencrypted versions to a file sharing network, where the unencrypted versions are variations of the documents encrypted in step 1002, and wherein the variations of the multiple encrypted documents include at least one selected from (a) a low-resolution version of the multiple encrypted documents and/or (b) a watermarked version of the multiple encrypted documents. According to one embodiment, the data file generated in step 1004 includes both a key_hash property that includes a sha256 hash of the symmetric key and a docroot pointing to the storage location of the NFT documents. According to various embodiments, the data file is uploaded to the same storage location (docroot) of the NFT documents). According to one embodiment, step 1006 includes setting a tokenURL (or equivalent) of the NFT to the location of the data file and also includes assigning the NFT to the wallet address of the user minting the NFT. According to one embodiment, an NFT cache record is created and stored on a database of the first host computer system, where the NFT cache record includes the user ID, a wallet address, a unique NFT identifier (including a blockchain identifier, a contract address and the NFT token ID), the symmetric key that is encrypted by the user's private document key, and the docroot pointing to the document storage location. Further, the system may respond to the initial request received, by providing a unique identifier of the newly created NFT, where the unique identifier includes NFT creation details (i.e., the chain and the contract or collection address) and the associated token ID of the newly created NFT.

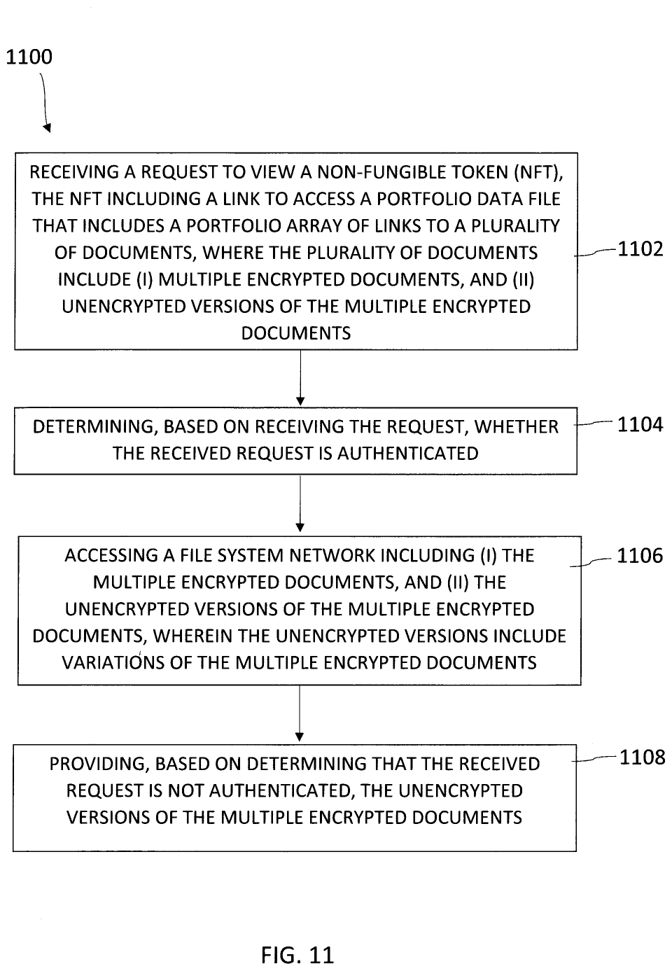

FIG. 11 depicts a flowchart of an example method 1100 for assessing authentication to access encrypted documents, according to an implementation of the present disclosure. At step 1102, a request is received to view an NFT, where the NFT includes a link (e.g., token URL) to access a portfolio data file that includes a portfolio array of links to a plurality of documents, where the plurality of documents include (i) multiple encrypted documents and (ii) unencrypted versions of the multiple encrypted documents, and where each link points to a single document of the plurality of documents. In particular, the portfolio data file includes portfolio details that include an array of document details that include paths to encrypted files and unencrypted files, including document previews. At step 1104, based on receiving the request the system determines whether the received request is authenticated. According to various embodiments, at step 1104, the determining includes verifying whether a user wallet currently connected to a user device from which the request was received matches to a current owner of the NFT. Further, at step 1104, the determining includes verifying that user credentials received as part of the request match credentials of an authorized user of the NFT that has been authorized by a current owner of the NFT. At step 1106, the system accesses a file system network that includes (i) the multiple encrypted documents, and (ii) unencrypted versions of the multiple encrypted documents, wherein the unencrypted versions are variations of the multiple encrypted documents. According to one embodiment, the variations include at least one selected from (a) a low-resolution version of the encrypted documents and/or (b) a watermarked version of the encrypted documents. At step 1108, the system provides, based on determining that the received request is not authenticated, the unencrypted versions of the multiple encrypted documents.

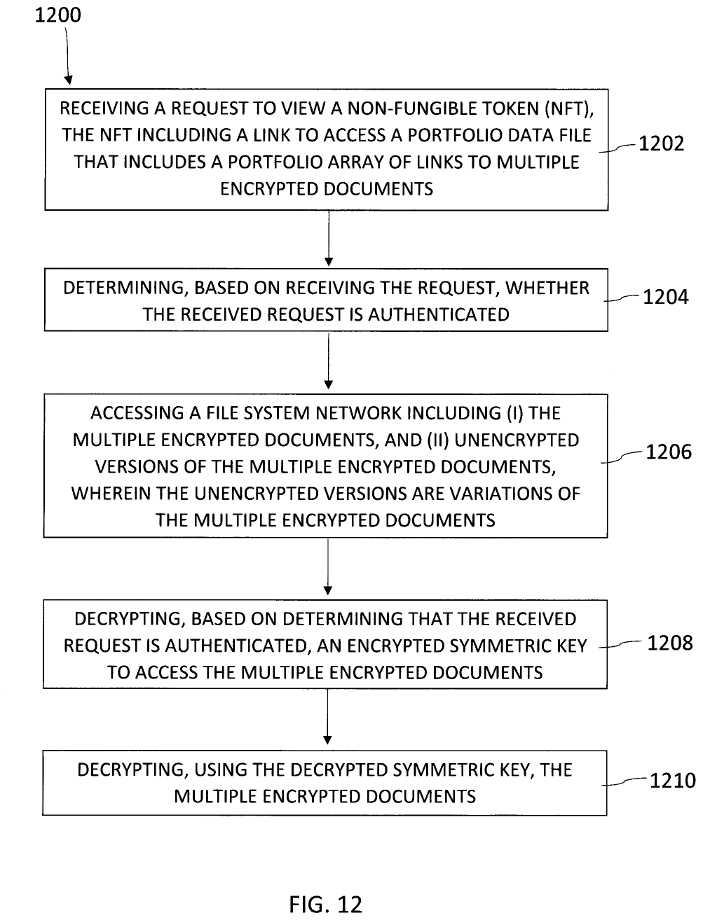

FIG. 12 depicts a flowchart of an example method 1200 for authorization of encrypted documents using blockchain distributed ledgers, according to an implementation of the present disclosure. At step 1202, a request is received to view an NFT that includes a link to access a portfolio data file that includes a portfolio array of links to, in part, multiple encrypted documents. At step 1204, based on receiving the request, the system determines whether the received request is authenticated. At step 1206, the system accesses a file system network that includes (i) the multiple encrypted documents, and (ii) unencrypted versions of the multiple encrypted documents, wherein the unencrypted versions are variations of the multiple encrypted documents. At step 1208, based on determining that the request received is authenticated, the system decrypts an encrypted symmetric key to access the multiple encrypted documents. At step 1210, the system decrypts, using the decrypted symmetric key, the multiple encrypted documents.

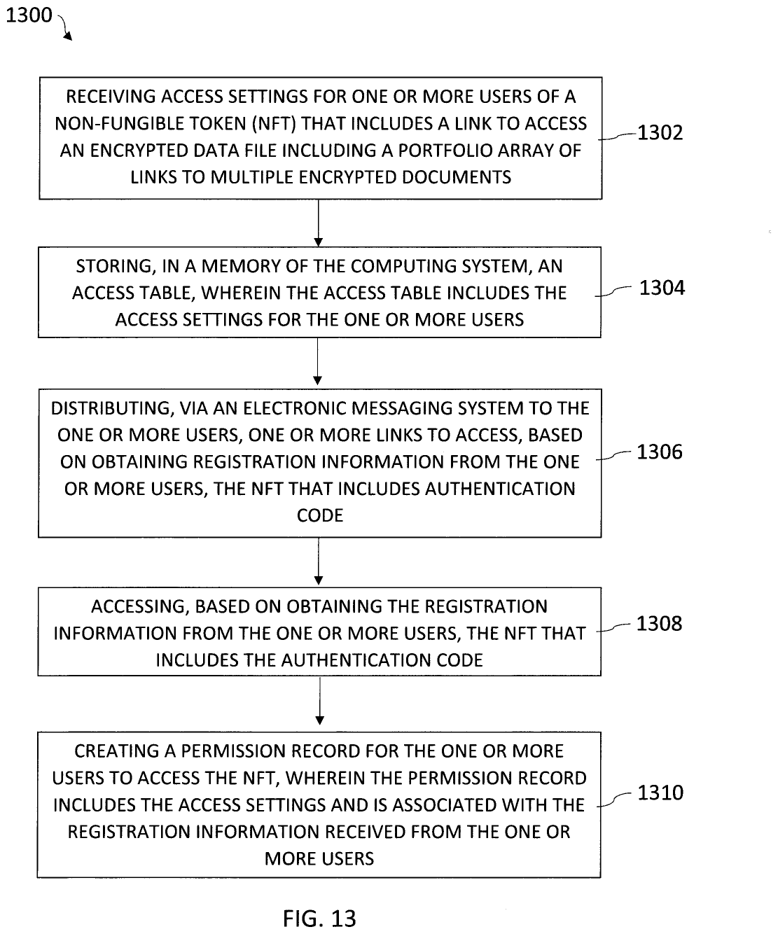

FIG. 13 depicts a flowchart of an example method 1300 for authorizing an additional user to access encrypted documents via an NFT that includes a link (i.e., tokenURL), according to an implementation of the present disclosure. According to one embodiment, the method 1300 may be initiated based on receiving a request to add or modify access permissions for a specific NFT that is owned by a user, where the user must be logged in to authenticate that the user requesting that access permissions be added or modified is authorized to perform such actions. Further, in order to initiate the method 1300, a webpage may be displayed via a user interface of a computing device of a user, where the webpage enables the user to set specific access permissions for each role (e.g., admin, guest, etc.) and for each document within a portfolio NFT that includes multiple encrypted documents.

In particular, the method 1300 creates access permissions for an NFT so that another individual can access the NFT, where the access permissions include a unique identifier (e.g., the chain, the contract or collection address, and the tokenID or metadata file path or docroot) of the NFT. In step 1302, access settings for one or more users of an NFT are received, where the access settings include the unique identifier of the NFT, which will enable the NFT to be identified. Once identified, an NFT will include a link to access a data file (e.g., metadata file) that includes a portfolio array of links to multiple encrypted documents. In some embodiments, the portfolio array of links may link to both the multiple encrypted documents as well as unencrypted documents. The webpage may display an “invite user” element and may allow a user (e.g., the NFT owner) to select whether the entire NFT or specific documents within the NFT. Step 1304 stores, in a memory of the computing system, an access table, where the access table includes the access settings for the one or more users, where the access settings may be derived based on inputs provided by the user. For example, the access table may store an invitee email address for a user, as well as accompanying access settings for that user. Further, the system may create one or more links to access the NFT. In step 1306, one or more links to access the NFT, or documents thereof, are distributed to one or more users via an electronic messaging system, where the links can be accessed based on obtaining registration information from the one or more uses. Once an invitee receives the invite link and selects the link, the user module may request an unencrypted version (e.g., a low-resolution image or a watermarked image) of the encrypted document and display or otherwise provide the unencrypted version to the invitee. Additionally, instructions may be provided to the invitee that would indicate how the invitee may view the full document(s) or other documents in the NFT by clicking one or more buttons (e.g., login/register button). The user may then input registration information into the system. In step 1308, based on obtaining the registration information from the one or more users, the system may process the information and the NFT is accessed. According to one embodiment, processing the registration information may include looking up the NFT referenced in the invite link that was clicked by the invitee and retrieving the owner's private document key. In step 1310, a permission record for one or more users to access the NFT is created, where the permission record includes access settings and is associated with registration information received from one or more users. Further, the permission record stores the public document key, which is derived from the owner's document private key, and stores the specified role of the invitee. The encrypted document may then be obtained from the file sharing network and the encrypted symmetric key and the key_hash may be obtained from the NFT cache. The system may then decrypt the symmetric key with the public document key, verify the symmetric key be comparing a sha256 hash of the symmetric key with the key_hash and then decrypt the document. Once this process is completed, the invitee webpage may display the decrypted document and may optionally display options to view other documents within the NFT.

According to various embodiments of the computing system disclosed herein, a user module may manage user accounts and a plurality of wallets for each user. The system may include an NFT management module communicating with a plurality of transaction modules that are each configured and connected to a unique blockchain network to perform transactions on the NFT's blockchain. The system may also include a document gateway that manages the encryption/decryption processes as well as the storage and retrieval of Portfolio documents and metadata files on a computer readable medium whether located at the first host computer system or remotely accessed on a file sharing network, such as IPFS, a blockchain-based data store, or hosted cloud storage such as Amazon S3. The system may also include a website that includes a user interface for interacting with a plurality of user devices. The user interface may include one or more actionable inputs that allow the system to perform various functionalities including, for example, user registration and password management, wallet configuration and management, user device registration, an NFT creation request, management of NFT access permissions, NFT synchronization, navigation and viewing, creation and acceptance of NFT viewing requests, and creation and acceptance of user invites. The user interface may include, according to one embodiment, an application programmable interface (API) for receiving requests from a third-party host computer system or client application for all or some of the functionalities.

According to various embodiments, also disclosed herein is a computer-readable storage medium that may be configured to perform a method to view secure documents of a portfolio NFT on a user-specified blockchain. In particular, the computer-readable storage medium may receive a view request from a host computer system to view an encrypted document of a portfolio NFT. Based on receiving the request, the computer-readable storage medium may extract a docroot from the URL and using the docroot, retrieve the unique NFT location details from the NFT Cache. The computer-readable storage medium may (a) verify the logged-in status, (b) authenticate user credentials, or (c) authenticate a device ID, and may (d) authenticate an authentication token depending on what information is supplied. If the user cannot be authenticated or logged in, the computer-readable storage medium may retrieve, for example, an unauthenticated version of the document (e.g., a low-resolution or watermarked image) from a file sharing network and provide the unauthenticated version to the user device requesting to view the encrypted document. Additionally, the method may retrieve the user ID, the user's public document key, encrypted symmetric, and the document key_hash from the database tables by using the NFT token ID. Additionally, the unique NFT location details may be used to retrieve the NFT from the blockchain. Ownership of the retrieved NFT may be verified, and if ownership has changed then the unauthenticated version may be retrieved and provided in response. Additionally all stale permission records may be removed based upon determining that ownership has changed. Further, if it is determined that the user is authenticated, the permission level of the user for this NFT is checked, and if the user does not have the desired permission level to access the full document, the unauthenticated version of the document (e.g., the low-resolution version or the watermarked version) may be provided. Alternatively, in another implementation, if the user does not have the desired permission level to access the full document then nothing is provided to the user.

According to one embodiment, the computer-readable storage medium may interact directly with the file system network (e.g., IPFS) to retrieve the encrypted documents, and may decrypt the encrypted symmetric key using the user's public document key. Further, the computer-readable storage medium may verify the hash of the decrypted symmetric key against the key_hash stored in the NFT cache for the requested NFT. The decrypted symmetric key may be used to decrypt the encrypted document, and the computer-readable storage medium may respond to the request to view the document with the decrypted document.

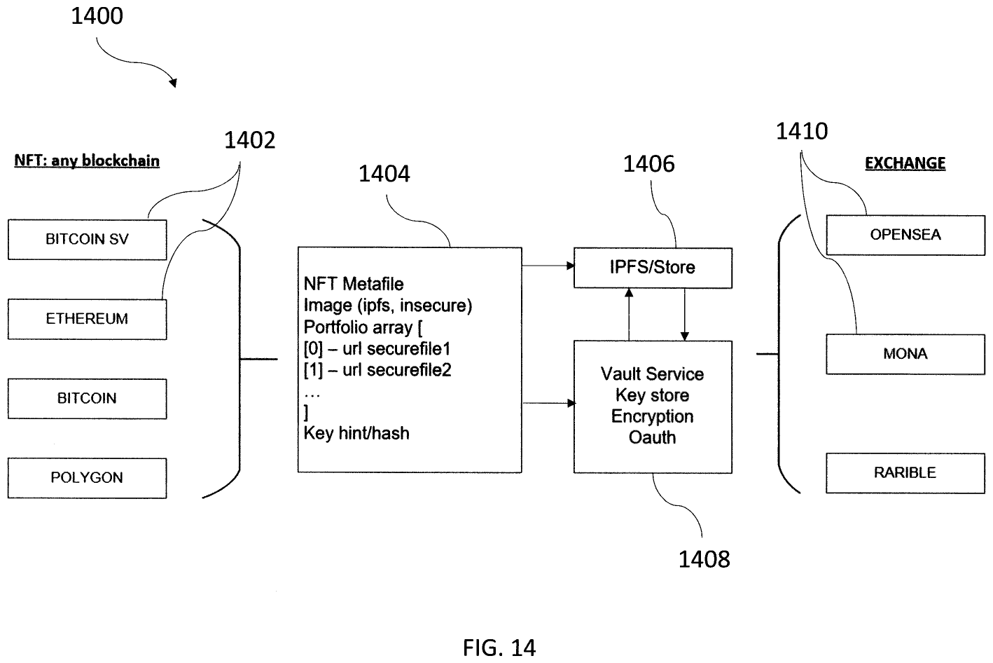

FIG. 14 depicts a block diagram of an asset privacy service 1400, according to an implementation of the present disclosure. As depicted, any blockchain 1402 such as, for example, BSV, Ethereum, Bitcoin, Polygon, etc. may be accessed by the asset privacy service 1400. In the NFT metafile 1404, such as, for example, an ERC721 NFT Metafile, is augmented to include a portfolio array. The standard “image” property may be reused to point to a standard, low-resolution image, making the secure portfolio NFT still viewable and tradeable on the standard NFT, e.g., the standard Ethereum NFT. The augmented metafile may be reused across all blockchains so that the NFTs are blockchain agnostic. Further, the NFT metafile 1404 includes a portfolio array with URLs to secure links hosted on the asset privacy service 1400. The asset privacy service may share OAUTH user security with a client exchange, thereby allowing users on the exchange to seamlessly log into the vault service 1408 of the asset privacy service 1400.

The vault service 1408 stores one unique symmetric key that has been additionally encrypted with the owner's document keys for each NFT, such that all portfolio images that are included in the single NFT are accessible via the same symmetric key; however, no other NFT can be accessed using that same symmetric key. The symmetric key may be encrypted by a user's unique public-private key pair such that other authorized users can be granted access to the portfolio images. In particular, the symmetric key may be encrypted by a public-private key pair associated with at least one selected from (a) an NFT owner and/or (b) an authorized user of the NFT. Further, the encrypted symmetric key may be stored separately from the NFT. When the owner's document public key is presented along with an authorized user's document private key, the symmetric key for the NFT is obtained and a secure file is decrypted. When the NFT is sold, the symmetric key is decoded with the seller's public & private key pair, and re-encrypted with the buyer's public & private document key pair, thereby decommissioning the seller's keys. During image creation, portfolio images are encrypted with the symmetric key and stored on the file system network 1406, shown as IPFS/Store, but other storage services could also be used. A hash of the symmetric key is stored in the NFT metafile 1404 to verify that the symmetric key obtained using the user's public key is correct. The vault service 1408 then returns the decrypted file to the calling exchange/API User. In an alternative embodiment, the system may hold an encrypted symmetric key using a system public-private key pair, enabling the system to decrypt and access the symmetric key, and re-encrypt for new owners and authorized users.

Advantageously, because a standard metafile 1404 is used across all blockchains 1402, the asset privacy service 1400 can easily be retrofitted to any existing NFT smart contracts and marketplace exchanges such as, for example, Opensea, Mona, Rarible, etc. As previously indicated, the standard metafile 1404 enables secure portfolio images to be added to NFTs on any blockchain.

Numerous variations of the asset privacy service 1400 exist. For instance, according to one embodiment, only a single encryption method may be used such that the NFT images are encrypted with only a symmetric key, thereby enabling all previous owners to retain access to the NFT documents. In contrast, re-encrypting the symmetric key with the new owner's key information, which is then stored in the vault service 1408, only the current owner (and the owner's authorized viewers) will have access to the NFT.

In another embodiment of asset privacy service 1400, the encrypted key may be stored on a blockchain 1402 with the NFT instead of being stored on a separate service 1408, and the encrypted key may be protected using a passphrase.

In yet another embodiment, asset privacy service 1400 may encrypt each component image with a different key, or all NFTs may be encrypted with the same key.

The examples provided herein are non-limiting examples, and various alternate solutions are also contemplated herein. For example, the host computing system may, according to one embodiment, be connected to only a single blockchain. In some embodiments, encryption of the symmetric key could be omitted, in which case all documents may be decrypted and re-encrypted based upon an ownership change. Other variations contemplated herein may use different methods of encryption. In one embodiment, low-resolution versions of the document(s) may be alternatively stored on a computer-readable storage medium, on the blockchain itself, or on some other storage medium rather than on the file sharing network. One example of this could be storing the low-resolution versions of the document(s) using cloud object storage (e.g., a third-party storage service such as Amazon Simple Storage Service (Amazon S3)).

Also contemplated herein are various methods for protecting a user's document private key including, for example, storing an encrypted copy in an http_only cookie or on local storage on a user device. Various best practices reflecting the best security methodologies currently available could be used to protect private data. In one embodiment, registration of a new user account may include sending a verification email or other electronic communication as part of the first step in the process such that the user may login only after being verified rather than allowing for automatic login capabilities. Two-step verification processes may also be used according to various embodiments.

Another example non-limiting implementation of NFT creation may vary slightly from the systems and methods referenced in the FIGS. above. In this example, at NFT creation, the original NFT symmetric key may be encrypted with the NFT Manager's (server's) pub key. This encrypted (exchangeKey) is stored in a security smart contract on a blockchain that is associated with the NFT contract address+tokenId+chain, and the symmetric key can only be decrypted with the server's private key. When the NFT is transferred to a new owner, the new owner may send a request to claim the private key. Based on receiving the request to claim the private key, the system may generate a User Wallet Secret (rather than the User Public Key described above) that is derived from the signature and public key of the user's current wallet. This process that utilizes the User Wallet Secret verifies requesting wallet has the same address and on same chain as the NFT to be claimed. Additionally, a user then signs message (claimSig) containing the tokenId of the NFT to be claimed. Further, a user device generates ephemeral key pair and the claimSig is sent to NFT Manager, along with an ephemeral public key. The NFT Manager then verifies that claimSig is signed by the same wallet as the current owner of the NFT. If the claimSig matches, then the NFT Manager retrieves an exchangeKey for the NFT from a security smart contract and performs decryption of the encrypted exchangeKey using the server private key, thereby extracting the NFT symmetric key. The NFT symmetric key is subsequently re-encrypted with an ephemeral public key of the user, creating a claimKey. Further, the NFT Manager sends the newly created claimKey to the user device.

For clarity, the claimKey referenced herein is a symmetric key (also termed NFT key that encrypts documents for a single NFT) that is additionally encrypted by both a private key of the owner and a public key of at least one of an authorized user and/or the owner. Unlike a wallet key, the document private key is generated by the system for a specific user. Each user ID is paired with an NFT so each NFT has its own unique claimKey, meaning a symmetric key (NFT key) encrypted by a private key of the owner and the public key of the user. The claimKey may be stored in the NFT cache record (i.e., as the encrypted symmetric key). For the owner of the NFT, the owner's claimKey that is stored in the NFT cache record would be the symmetric key (NFT key) that is encrypted by both the owner's private key and the owner's public key.

In contrast, for an authorized user of the NFT that is not the owner of the NFT, the user's claimKey would by a symmetric key (NFT key) that is encrypted by the owner's private key and the user's public key. The user's claimKey is created when the owner sends an invite to the user to allow the user to view the NFT.

Once a claimKey is received, the user device is used to decrypt the claimKey. The process differs depending on whether the user device performing the decrypting is operated by an owner of the NFT or an authorized user of the NFT. In one example method, if an authorized user is attempting to view the NFT, the claimKey would be decrypted using the owner document public key (stored in a permission table) and the user's document private key (stored in a user table). The respective permission table and user table would necessarily need to be checked to ensure that the user is, in fact, authorized to view the NFT. If necessary, the system can calculate an authorized user's document public key by referencing the authorized user's document private key found in the authorized user's user table.

To ensure the safety of a user's document private keys, these user document private keys can additionally be encrypted by a system secret key. In this embodiment that incorporates the system secret key, the claimKey is decrypted with the ephemeral document private key of a user of the user device and the document public key of the owner to get the NFT symmetric key. This NFT symmetric key is then re-encrypted with the User Wallet Secret for the current wallet using symmetric encryption and stored in the user device's local store (the “NFTsecret”). Advantageously, this implementation provides support for multiple editions (multiple owners) of a single RFC 1155. Other implementations where the NFTsecret is stored on the security smart contract associated with the NFT tokenId, contract address and blockchain are also contemplated herein. Additionally, the described process may require a user to reclaim the key on any new device or after a configurable cookie time-out.

An example process for transferring a key occurs when a new owner purchases an NFT. To open the newly purchased NFT, the system either generates a new document private key for the new owner, or pulls the owner's existing document private key. The system would not have an NFT cache record for this new owner, the new owner's currently selected wallet, or the NFT to be opened. As a result, the system loads the NFT and verifies that the wallet address corresponds to the owner's wallet to verify that the new owner purchased the NFT. If, during the verification process the system is unable to ensure that the wallet address corresponds to the owner's wallet then, according to one embodiment, the system may display a preview of the NFT and does not decrypt the NFT. If, alternatively, during the verification process the system determines that the wallet address corresponds to the owner's wallet, then the system retrieves the most recent NFT cache record matching the NFT. Specifically, the most recent NFT cache record would include the last claimKey from the last owner of the NFT. The system then retrieves a user record matching the user ID of the new owner, where the user record includes the new owner's private key. The system then decrypts the claimKey using the last owner's calculated public key (obtained from the stored document private key) and the last owner's private key, thereby accessing the symmetric key. The system subsequently creates a new NFT cache record for the new owner and stores the newly created claimKey that incorporates the new owner's document private key and calculated document public key.

Additional non-limiting descriptions of the FIGS. above are also provided. For instance, further referencing FIG. 4 described above, according to various embodiments, various data files, such as example data file 400, may optionally reference the file sharing network using, for example, “ipfs://” or a “https://” URL. For example, the URL may point directly to an IPFS preview of the document instead of to a website of the file sharing network.

Further referencing FIG. 5 described above, according to one embodiment, user device 502 may execute JAVASCRIPT and the host computing system that performs various processes described by sequence diagram 500 implements much of the server code via a NEXTJS application, where NEXTJS is a progressive web application (PWA) where only particularly sensitive code runs on the server (e.g., authentication/tokens and smart contract interactions).

With further reference to FIG. 6 described above, check performed by the document gateway 615 at step 670B may include checking that the current wallet address matches the current owner of the NFT being viewed by connecting to a third-party wallet application, and may optionally omit checking for user credentials via a user login process. Also, step 670D may be optionally modified from the process depicted, since there may not be a double encrypted document key and rather the document gateway 615 may access a local storage device, which advantageously may allow for multiple potential owners for each NFT, among other advantages. With further reference to FIG. 6 described above, according to one embodiment, when the NFT management module 614 communicates with the blockchain 652, 654 to retrieve the NFT, the NFT may be identified at 670E by more than the just the token ID, and may be identified by contract address, token ID, and chain ID. Also contemplated herein, when the document gateway verifies that the owner wallet address in the NFT is authenticated, at step 670H, in various embodiments the NFT cache may only store NFTsecret for each NFT, which optionally may incorporate a substitute process for comparing the wallet address to the NFT cache. The NFT cache may store various information including, a link to a data file (e.g., a metadata link), a file sharing network (e.g., IPFS) identifier for the metadata file to facilitate lookup of the cache record. According to various implementations, the key_hash described in step 670K may optionally be omitted, and in one example could be substituted with a checksum or other data that is appended to the end or prepended to the beginning of the document, which may be verified once the document is decrypted to ensure that the document was successfully decrypted. In various embodiments, certain information (e.g., user ID, wallet address, the symmetric key encrypted by the user's private document key, etc.) may be obtained from the blockchain itself (e.g. in a smart contract) rather than from the NFT cache record. Specifically, the symmetric key that may be encrypted by the user's private document key may be stored separately from the NFT and is accessible only by the owner and the authorized users.

With further reference to FIG. 7 described above, according to various embodiments, the process of registering user wallets or creating wallets described in 770A may utilize existing third-party wallets such as, for example, MetaMask wallet, Phantom Wallet, Temple Wallet, Blocto, etc. for wallet generation, private key storage, and recovery. According to one embodiment, the process described in 770D that is used to retrieve NFTs stored in a user's wallet for a specified blockchain may optionally omit storage of the NFT in an NFT cache on a computer-readable storage medium. Additionally, according to one embodiment, once a data file is retrieved from a file sharing network in step 770E, comparing the key_hash stored thereon against the decrypted symmetric key to ensure the key_hash matches the decrypted symmetric key may not be an automatic process and may, for example be a manual ClaimKey process that is performed by an owner after the owned NFT is opened for viewing.

With further reference to FIG. 8 described above, according to one embodiment, there may not be a central database 800 for storage of key data and/or permission data. Rather, for example, user data may be stored on a cloud database and would not include key data or wallet data. Claimed keys (e.g., NFTsecret) may be stored on a user device in local storage, which may require a signature of the NFT owner to decrypt and expose the NFT symmetric key that would be required to decrypt an NFT. In various embodiments, permissions and multi-user access rights may be stored, for example, in a smart contract.

Although various computing environments are described above, these are only examples that can be used to incorporate and use one or more embodiments. Many variations are possible.

Further example embodiments disclosed herein may be configured using a computer program product, wherein controls may be programmed into software to implement example embodiments. Further example embodiments may include a non-transitory computer-readable storage medium that includes instructions that may be executed by a processor which, when loaded and executed, cause the processor to complete the methods described herein. Various elements of the block and flow diagrams disclosed herein may be performed, combined, or divided in any manner of software, hardware, or firmware. If implemented in software, the software may be written in any language that can support the example embodiments disclosed herein. Various forms of computer readable storage medium may store the software including, for example, random access memory (RAM), read-only memory (ROM), compact disk read-only memory (CD-ROM), etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A computing system for encryption using blockchain distributed ledgers, the computing system comprising:
a memory;
one or more processors in communication with the memory; and
program instructions executable, via the memory, by the one or more processors to:
encrypt, via a symmetric key, multiple documents to be incorporated into a single non-fungible token (NFT);
generate a data file comprising a portfolio array of links to each encrypted document of the multiple encrypted documents;
execute a mint function to create the single NFT on a blockchain, the single NFT including a link to the generated data file; and
transmit the single NFT to a digital wallet of the blockchain.

2. The computing system of claim 1, wherein the program instructions further generate the symmetric key to perform the encryption of the multiple documents.

3. The computing system of claim 1, wherein the symmetric key is configured to encrypt and decrypt the multiple documents.

4. The computing system of claim 1, wherein the program instructions further upload to a file system network (i) the multiple encrypted documents, and (ii) unencrypted versions of the multiple encrypted documents, wherein the unencrypted versions are variations of the multiple encrypted documents, and wherein the variations of the multiple encrypted documents include at least one selected from (a) a low-resolution version of the multiple encrypted documents and/or (b) a watermarked version of the multiple encrypted documents.

5. The computing system of claim 1, wherein the generated data file includes contents of a metadata.json file.

6. The computing system of claim 1, wherein the generated data file further includes a key_hash property, wherein the key_hash property includes a Secure Hash Algorithm 256-bit (SHA-256 hash) of the symmetric key.

7. The computing system of claim 1, wherein the program instructions further upload the generated data file to a file system network that allows for the generated data file to be retrieved via the link that is included in the single NFT.

8. The computing system of claim 1, wherein the minting further includes setting the link to the generated data file, wherein the link includes a tokenURL.

9. The computing system of claim 1, wherein the digital wallet includes a wallet address of a user.

10. The computing system of claim 1, wherein the program instructions further create an NFT-cache record of the single NFT, wherein the NFT-cache record includes a user ID, a wallet address of the digital wallet, a unique identifier of the single NFT that includes a blockchain identifier identifying both (a) the blockchain and (b) an NFT token ID of the single NFT, and the encrypted symmetric key.

11. The computing system of claim 10, wherein the program instructions store the NFT-cache record on a database accessible to the computing system.

12. The computing system of claim 1, wherein the symmetric key is encrypted by a public-private key pair associated with at least one selected from (a) an NFT owner and/or (b) an authorized user of the NFT, wherein the encrypted symmetric key is stored separately from the NFT.

13. The computing system of claim 1, wherein the encrypting is based on receiving a request from a computing device of a user to create the single NFT on the blockchain.

14. The computing system of claim 13, wherein the program instructions further provide, to the computing device of the user, a response that includes a unique identifier of the single NFT, wherein the unique identifier includes an NFT token ID of the single NFT and creation details of the single NFT.

15. A computer-implemented method for encryption using blockchain distributed ledgers, the computer-implemented method comprising:
encrypting, via a symmetric key, multiple documents to be incorporated into a single non-fungible token (NFT);
generating a data file comprising a portfolio array of links to a plurality of documents, wherein the plurality of documents include the multiple encrypted documents, wherein each link points to a single document of the plurality of documents;
executing a mint function to create the single NFT on a blockchain, the single NFT including a link to the generated data file; and
transmitting the single NFT to a digital wallet of the blockchain.

16. The computer-implemented method of claim 15, wherein the plurality of documents further include unencrypted versions of the multiple encrypted documents wherein the unencrypted versions include variations of the multiple encrypted documents, and wherein the variations of the multiple encrypted documents include at least one selected from (a) a low-resolution version of the multiple encrypted documents and/or (b) a watermarked version of the multiple encrypted documents.

17. A computer-implemented method for assessing authentication to access encrypted documents, the computer-implemented method comprising:
receiving a request to view a non-fungible token (NFT) comprising a link to access a data file comprising a portfolio array of links to multiple encrypted documents;
determining, based on receiving the request, whether the received request is authenticated;
accessing a file system network comprising (i) the multiple encrypted documents, and (ii) unencrypted versions of the multiple encrypted documents, wherein the unencrypted versions include variations of the multiple encrypted documents; and
providing, based on the determining indicating that the received request is not authenticated, the unencrypted versions of the multiple encrypted documents.

18. The computer-implemented method of claim 17, wherein the determining includes verifying whether a user wallet currently connected to a user device from which the request was received matches to a current owner of the NFT.

19. The computer-implemented method of claim 17, wherein the determining includes verifying that user credentials received as part of the request match credentials of an authorized user of the NFT that has been authorized by a current owner of the NFT.

20. The computer-implemented method of claim 17, wherein the variations include at least one selected from (a) a low-resolution version of the encrypted documents and/or (b) a watermarked version of the encrypted documents.
